(19) United States
(12) Patent Application Publication
(10) Pub. No.: US 2006/0177047 A1
(43) Pub. Date: Aug. 10, 2006

(54) Keypad guard for providing security and preventing vandalism to a pay telephone keypad

(76) Inventors: David Grudzinski, Houston, TX (US); William W. White, Houston, TX (US)

Correspondence Address: KEELING PATENTS AND TRADEMARKS, 3310 KATY FREEWAY, SUITE 100, HOUSTON, TX, 77007, US

(21) Appl. No.: 11/040,466

(22) Filed: Jan. 21, 2005

(51) Int. Cl. H04M 1/00

(52) U.S. Cl. 379/433.07

(57) ABSTRACT

The invention is a guard for preventing the vandalism of a pay telephone keypad. Additionally, the invention prevents access to a pay telephone coin vault through the keypad. The inventive guard includes a plurality of attachment points. The attachment points have a shoulder raised above the exterior surface of the inventive guard. When a fastener is inserted through the attachment point, the head of the fastener will be flush or inset with respect to the top surface of the shoulder, thereby preventing leveraging against the fastener head. Additionally, a de minimus gap formed between the perimeter of the fastener head and the inner wall of the shoulder prevents insertion of a prying instrument.

### CROSS-REFERENCE TO RELATED APPLICATIONS

Not Applicable.

### STATEMENT REGARDING FEDERALLY SPONSORED RESEARCH OR DEVELOPMENT

Not Applicable.

### BACKGROUND OF THE INVENTION

1. Field of the Invention

The present invention relates generally to a guard that prevents the destruction and vandalism of the keypad of a pay telephone. Specifically, this invention is a keypad guard that prevents a potential vandal from damaging the pay telephone keypad and from gaining access to the pay telephone vault.

Pay telephones are typically installed in isolated, unprotected locations. Over a prolonged period of time, an amount of coin money is retained within the vault of a pay telephone. Consequently, pay telephones are the subject of frequent vandalism attempts.

Vandals use a variety of means to gain access to the pay telephone vault, including smashing through the pay telephone keypad or drilling through the telephone housing. The pay telephone keypad is typically positioned directly above the open-top coin vault drawer. Consequently, vandals smash through the telephone keypad in order to gain access to the pay telephone vault. Alternatively, vandals may attempt to drill through the pay telephone upper housing in order to gain access to the coin vault. The present invention is directed to preventing vandalism to the telephone keypad and preventing access to money in the pay telephone coin vault by protecting the keypad assembly. Additionally, the present invention increases security to the pay telephone by providing armor protection to the pay telephone upper housing, thereby preventing drilling of the pay telephone upper housing.

Pay telephones are also the subject of frequent abuse. In addition to vandals, customers may become angry and hit the keypad. If repeated, excessive force is applied to the keypad pushbuttons, the internal springs may become damaged and ultimately inoperative. Therefore, the present invention is also directed to preventing excessive force from being applied to the keypad, thereby protecting the functionality of the pushbuttons.

2. Description of the Related Art

Several inventions to prevent vandalism and destruction of pay telephone keypads are known to the art. This includes single piece face plates. Prior art faceplates have typically been of light metal or heavy plastic, which affords minimal protection. Other prior art replaces the pay telephone upper housing with a stronger, more intimidating shield. Because the shield serves as a replacement for the upper housing, extensive retrofitting is required.

U.S. Des. Pat. No. D353,137 issued to DeArkland on Dec. 6, 1994 discloses a face panel for a payphone. The panel comprises a faceplate with openings for the individual keys, the coin insertion slot, information signs, the coin return lever, the coin vault, etc. The faceplate is for ornamentation only and does not provide security against vandalism.

U.S. Pat. No. 5,134,654 issued to McGough on Jul. 28, 1992 discloses an upper housing shield for a payphone comprising a thick metal plate formed to a “U” shape to wrap around existing payphones. Holes are formed into the housing for the lock, handset cord, coin slot, coin instruction plate, coin release mechanism, etc. The housing shield replaces the standard faceplate on a pay telephone and is attached to the payphone by welding. Thus, McGough requires retrofitting existing pay telephones by completely removing the preexisting upper housing and welding the new housing shield to the preexisting lower housing. This process is exceedingly difficult to complete in the field.

U.S. Pat. No. 6,317,496 issued to White et al. on Nov. 13, 2001 discloses a guard for preventing the vandalism of a telephone. The guard is composed of an upper housing guard and keypad guard. The keypad guard is secured to the upper housing guard by high strength, visible fasteners. The upper housing guard is secured to the pay telephone's upper housing by an attachment means known in the art, such as welding or with bolts in conjunction with countersunk holes. Welding the guard can be difficult on existing pay telephones. Additionally, use of countersunk holes reduces the overall strength of the guard by providing a weakened point in the guard due to the decreased thickness of the metal at the countersunk hole.

U.S. Pat. No. 4,160,136 issued to McGough on Jul. 3, 1979 discloses an anti-vandalism device for coin telephones. The invention includes a cover having a plurality of apertures, and a base having a plurality of cavities. Pushbuttons extend from the base through the cavities and finally through the,apertures. The pushbuttons are L-shaped, and a flange, interposed between the pushbuttons and the base, prevents the pushbuttons from being fully depressed, thereby alleviating any stress on the spring. The pushbuttons are adapted to replace the standard pushbuttons of a typical keypad.

It would thus be beneficial to the prior art to provide a pay telephone keypad guard that deters a vandal from damaging the telephone keypad. It would further be beneficial to prevent a vandal from destructively removing the keypad to gain access to the money in the pay telephone coin vault. It would further be beneficial to protect the upper housing of the pay telephone. It would further be beneficial to provide a pay telephone keypad guard that is relatively inexpensive, simple to manufacture, and has a secure exterior appearance. Moreover, it would be beneficial that the pay telephone keypad guard be installed quickly and easily and require little retrofitting to the pay telephone.

### BRIEF SUMMARY OF THE INVENTION

Accordingly, it is an object of the present invention to provide a new and improved telephone keypad guard that:
Protects the telephone keypad from striking blows or other vandalism;
Prevents a vandal from destructively removing the keypad to gain access to money in the coin vault;
Protects the upper housing from drilling or other vandalism;
Is relatively inexpensive and simple to manufacture;
Requires little retrofitting to the pay telephone; and
Can be installed easily and quickly.

To achieve such improvements, the present invention is a pay telephone keypad guard that prevents vandalism of the pay telephone keypad. The objectives are accomplished by the structure and method of installation of the inventive keypad guard.

A critical feature of the keypad guard is its thickness, which reinforces the strength of the upper housing and protects the functionality of the keypad when struck by excessive force. The thickness of the invention provides reinforced strength to the guard, preventing striking blows from destroying the pay telephone upper housing. Additionally, the keypad guard is installed on top of the existing faceplate of the pay telephone, which increases the overall thickness.

A further critical feature of the vault guard is the construction of the keypad guard, which surrounds the non-mounting sides of the pay telephone, and which, by virtue of raised shoulders surrounding the attachment points, prevents the application of a tortion about the attachment means.

A further critical feature of the invention is the use of impact rivets, or equivalent single-use attachment means. The impact rivets may be applied entirely externally, thereby avoiding the need to disassemble, even partly, the pay telephone.

A further critical feature of the keypad guard is the attachment passages. The attachment passages are configured to prevent a vandal from gaining the leverage necessary to pry off the fasteners used to attach the keypad guard to the pay telephone upper housing.

Other objects of the invention will become apparent from time to time throughout the specification hereinafter disclosed.

### BRIEF DESCRIPTION OF THE DRAWINGS

FIG. 1 is an explosion view of the preferred embodiment and a pay telephone.

FIG. 2 is a perspective view of the preferred embodiment of the invention.

FIG. 3 is an isometric view of the second side plate.

### DESCRIPTION OF THE INVENTION

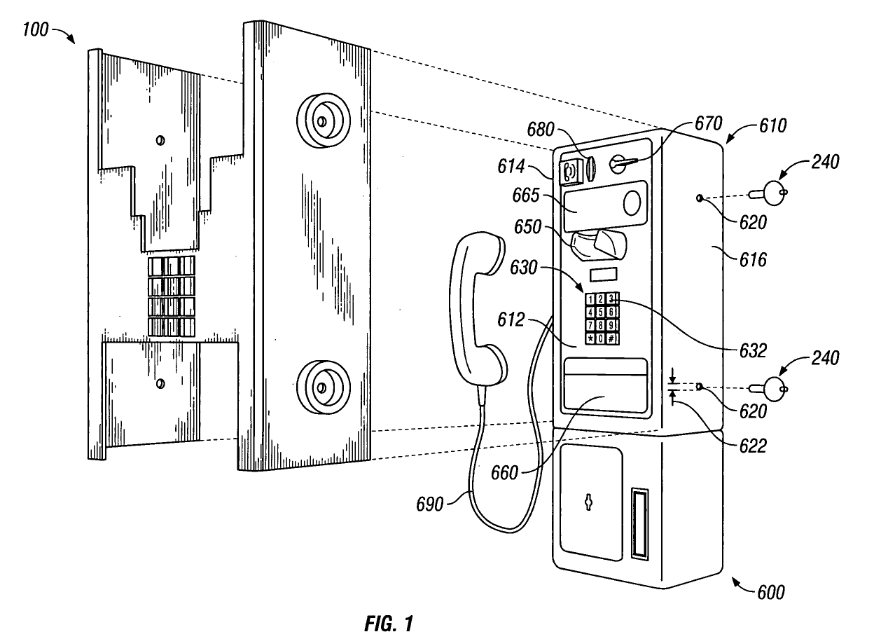

The keypad guard is shown generally in FIGS. 1-3 as keypad guard 100.

FIG. 1 illustrates keypad guard 100 attached to pay telephone 600. The attachment portion of keypad guard 100 is generally C-shaped and has internal dimensions nearly identical, absent tolerances, as the exterior surface of pay telephone upper housing 610, such that keypad guard 100 is superposed about pay telephone upper housing 610. Keypad guard 100 is preferably high strength metal, with sufficient strength and thickness to protect against drilling and heavy striking blows from vandals.

Keypad guard 100 includes a plurality of component openings 124, which permit access to common functional components of pay telephone 600. Common functional components include handset cradle 650, dialing information panel 660, advertisement 665, coin slot 680, coin return lever 670, handset cord 690, etc, seen in FIG. 1. Keypad guard 100 also includes a plurality of push button cavities 126, typically twelve in number, aligned in four rows of three each. Push button cavities 126 align with and receive a plurality of keypad push buttons 632.

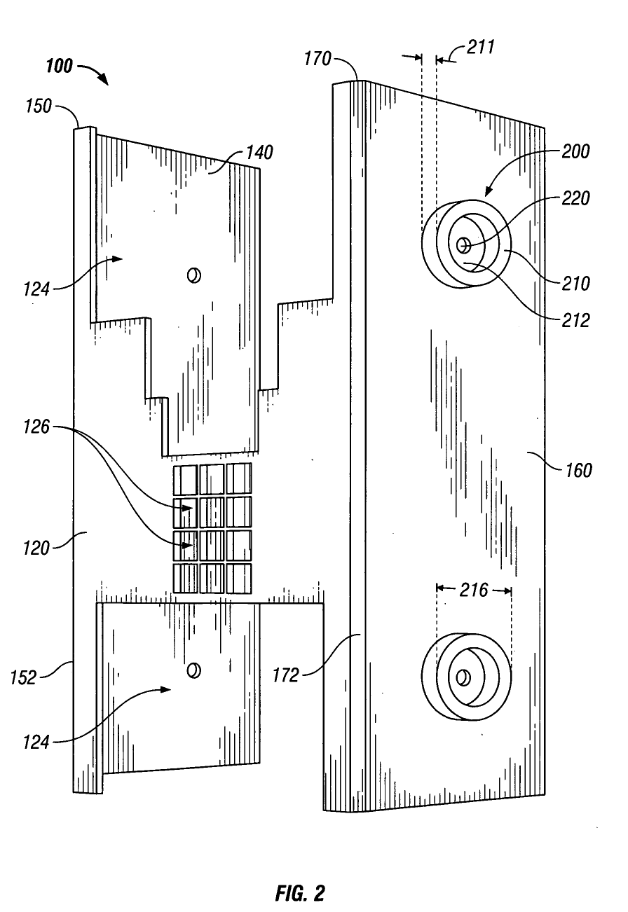

Keypad guard 100 is shown separately in FIG. 2. Keypad guard 100 is formed by face plate 120, first side plate 140, and second side plate 160. Face plate 120, first side plate 140 and second side plate 160 are of high strength and uniform thickness. First side plate 140 is joined rearwardly perpendicular to face plate 120 at junction 150, forming longitudinal edge 152. Second side plate 130 is likewise joined rearwardly perpendicular to face plate 110 at junction 170, forming longitudinal edge 172. Junctions 150 and 170 may be formed by welding or by bending of a single metal plate. Longitudinal edges 152 and 172 may be beveled with respect to first side plate 140 and face plate 120 and with respect to second side plate 160 and face plate 120, respectively. Beveling of longitudinal edges 152 and 172 permits keypad guard 100 to contour to the exterior of pay telephone upper housing 610, reducing potential space between keypad guard 100 and pay telephone upper housing 610, which may be used as a point of leverage. Alternatively, junctions 150 and 170 may be radiused to reduce potential space.

Keypad guard 100 is preferably high strength metal, with sufficient strength and thickness to protect against heavy striking blows from vandals. Keypad guard 100 should be sufficiently thick to prevent damage to pushbuttons 632 when heavy blows depress pushbuttons 632. Each pushbutton 632 of the keypad 630 has a throw distance (not shown), defined as the distance required to depress the keypad push button until an associated electrical switch is engaged, thus completing the electrical circuit signaling the entry of the number or function associated with the keypad pushbutton 632. In the present invention, the thickness of the keypad guard 100 is such that the keypad pushbutton 632 is inset with respect to the surface plane of face plate 120 after keypad pushbutton 632 traverses the throw distance. This prevents damage to the keypad push buttons 632 and their associated electrical switches when struck by excessive force.

Keypad guard 100 provides protection for keypad 630 through the mating of keypad guard 100 to pay telephone upper housing 610. As seen in FIG. 1, pay telephone upper housing 610 includes face member 612, first side wall 614, and second side wall 616. Keypad guard 100 is properly aligned and superposed about pay telephone upper housing 610.

Keypad guard 100 is secured to upper housing 610 through a plurality of attachment receivers 200. Referring to FIG. 2, two attachment receivers 200 are located on first side plate 140. Similarly, two attachment receivers 200 are located on second side plate 160.

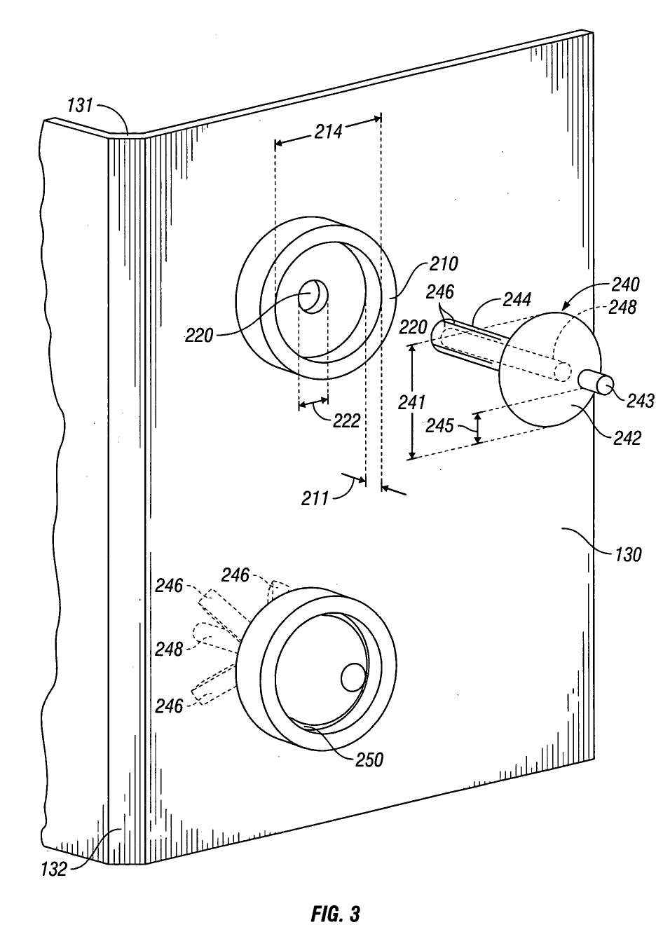

As seen in FIG. 2, attachment receiver 200 is comprised of receiver rim 210, receiver base 212, and bolt hole 220. Bolt hole 220 provides communication between keypad guard 100 and pay telephone upper housing 610. Receiver base 212 is at least the same thickness as first side plate 140, second side plate 160, and face plate 120. Bolt hole 220 extends through receiver base 212. Receiver rim 210 is concentric with bolt hole 220. As shown in FIG. 3, receiver rim 210 is raised a rim distance 211 above receiver base 212. Rim distance 211 is of sufficient height such that it alters the leverage point of a pry bar (not shown), preventing a vandal from prying off attachment bolt 240.

Referring to FIGS. 2-3, receiver rim 210 has inner diameter 214 and outer diameter 216, with inner diameter 214 larger than bolt hole diameter 222. Attachment bolt 240 may be used to fasten keypad guard 100 to upper housing 610. Attachment bolt 240 may be a rivet, or other similar securing means. Referring to FIG. 3, attachment bolt 240 comprises bolt head 242 and bolt shaft 244. Bolt head 242 has a -bolt head diameter 241 sized to fit within inner diameter 214. Bolt shaft 244 is partitioned into a plurality of shaft fingers 246, which are positioned about shaft axis member 248. Shaft axis member 248 communicates with bolt tip 243, such that when force is applied to bolt tip 243, bolt tip 243 and shaft axis member 248 are projected forward, causing shaft fingers 246 to expand radially, thus mushrooming within pay telephone upper housing 610. Alternatively, any externally-applied connector, such as a moly bolt with a detactable head, may be used so long as once applied, no point of leverage exists.

Referring to FIG. 3, after attachment bolt 240 is forcibly driven through bolt hole 220, the resulting space between inner diameter 214 and bolt head 242 is bolt gap 250. Bolt gap 250 should be less than one millimeter, such that it prevents the insertion of a pry bar or similar tool between inner diameter 214 and bolt head 242. Preventing insertion of a pry bar greatly decreases the ability of removing attachment bolt 240. When attachment bolt 240 is forcibly driven through bolt hole 220, bolt head tip 243 can be inset, flush, or outset with respect to receiver rim 210. Rim distance 211 must be sufficient to eliminate the prying surface created by the base of bolt head 242. Therefore, in the preferred embodiment, rim distance 211 is at least one-half of bolt head height 245. Once attachment bolt 240 is properly installed, bolt head 242 should have no wrenching surfaces.

Bolt head 242 may also be of any shape, so long as bolt gap 250 is less than 1 millimeter and rim distance 211 is at least one-half of bolt head height 245. Attachment bolt 240 should be of high strength and remain externally visible to convey an appearance of structural substance in order to deter vandalism.

In practice, housing holes 620 are drilled into first side wall 614 and second side wall 616 of upper housing 610, as seen in FIG. 1. Housing hole 620 has housing hole diameter 622 that is substantially similar in diameter to bolt hole diameter 222. Additionally, housing holes 620 are aligned with bolt holes 220. Bolt shaft 244 is sized to be received within bolt hole 220 and housing hole 620. When attachment bolt 240, bolt hole 220, and housing hole 620 are aligned, force is exerted onto bolt head 242 and bolt head tip 243, thereby thrusting bolt shaft 244 through bolt hole 220 and housing hole 620, thereby joining keypad guard 100 and pay telephone upper housing 610. This method of installation allows keypad guard 100 to be quickly and easily secured to pay telephone upper housing 610 without necessitating removal of parts. Additionally, the installation method permits installation of the keypad guard 100 onto a pay telephone 600 already existing in the field.

The foregoing description of the invention illustrates a preferred embodiment thereof. Various changes may be made in the details of the illustrated construction within the scope of the appended claims without departing from the true spirit of the invention. The present invention should only be limited by the claims and their equivalents.

What is claimed is:

1. A keypad guard for a pay telephone, said pay telephone having an upper housing, said keypad guard comprising:
a face plate and at least two side plates;
said face plate and said at least two side plates each constructed of an impact-resistant material;
each of said at least two side plates connected to said face plate;
said face plate and said at least two side plates configured to closely fit around at least three side of said upper housing;
said face plate including at least one access opening;
said at least one access opening providing access to at least one functional component of said pay telephone;
said at least two side plates each having at least one attachment receiver;
said at least one attachment receiver comprising a receiver base and a receiver rim;
said receiver base defining a bolt hole;
said bolt hole concentric with said receiver base; and
each said receiver rim extending outwardly from said side plate a rim distance.

2. A keypad guard as in claim 1, wherein:
said functional component is a member of the group consisting of:
(a) keypad pushbuttons;
(b) coin slot;
(c) coin return lever;
(d) information panel;
(e) handset cradle; and
(f) handset cord.

3. A keypad guard as in claim 1, wherein:
at least one single-use attachment bolt for each said at least attachment receiver.

4. A keypad guard as in claim 3, said keypad guard further comprising:
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head; and said shaft fingers axially expanding from said shaft axis upon forcible insertion of said attachment bolt shaft through said bolt hole.

5. A keypad guard as in claim 4, wherein:
said bolt head having no wrenching surfaces.

6. A keypad guard as in claim 4, wherein:
said attachment bolt head has an attachment bolt head height; and
said rim distance is at least one-half of said attachment bolt head height.

7. A keypad guard for a pay telephone, said pay telephone having an upper housing, said keypad guard comprising:
a face plate and at least two side plates;
said face plate and said at least two side plates each constructed of an impact-resistant material;
each of said at least two side plates connected to said face plate;
said face plate and said at least two side plates configured to closely fit around at least three side of said upper housing;
said face plate including at least one access opening;
said at least one access opening providing access to at least one functional component of said pay telephone;
said at least two side plates each having at least one attachment receiver;
said at least one attachment receiver comprising a receiver base and a receiver rim;
said receiver base defining a bolt hole;
said bolt hole concentric with said receiver base;
each said receiver rim extending outwardly from said side plate a rim distance;
at least one single-use attachment bolt for each said at least attachment receiver;
said attachment bolt head has an attachment bolt head height; and
said rim distance is at least one-half of said attachment bolt head height.

8. A keypad guard as in claim 7, wherein:
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head; and said shaft fingers axially expanding from said shaft axis upon forcible insertion of said attachment bolt shaft through said bolt hole.

9. A keypad guard for a pay telephone, said pay telephone having an upper housing, said keypad guard comprising:
a face plate and at least two side plates;
said face plate and said at least two side plates each constructed of an impact-resistant material;
each of said at least two side plates connected to said face plate;
said face plate and said at least two side plates configured to closely fit around at least three side of said upper housing;
said face plate including at least one access opening;
said at least one access opening providing access to at least one functional component of said pay telephone;
said functional component is a member of the group consisting of:
(a) keypad pushbuttons;
(b) coin slot;
(c) coin return lever;
(d) information panel;
(e) handset cradle; and
(f) handset cord
said at least two side plates each having at least one attachment receiver;
said at least one attachment receiver comprising a receiver base and a receiver rim;
said receiver base defining a bolt hole;
said bolt hole concentric with said receiver base;
each said receiver rim extending outwardly from said side plate a rim distance;
at least one single-use attachment bolt for each said at least attachment receiver;
each said at least one attachment bolt having an integrally formed attachment bolt head and attachment bolt shaft;
said attachment bolt shaft axially aligned with said attachment bolt head;
said attachment bolt shaft is partitioned into a plurality of shaft fingers;
said shaft fingers surround a shaft axis;
said shaft axis projecting out a bolt head tip of said attachment bolt head;
said shaft fingers axially expanding from said shaft axis upon forcible insertion of said attachment bolt shaft through said bolt hole;
said attachment bolt head has an attachment bolt head height; and
said rim distance is at least one-half of said attachment bolt head height.
